(19) United States
(12) Patent Application Publication
(10) Pub. No.: US 2002/0113872 A1
(43) Pub. Date: Aug. 22, 2002

(54) Information transmitting system

(76) Inventor: Naoto Kinjo, Kanagawa (JP)

Correspondence Address: BIRCH STEWART KOLASCH & BIRCH, PO BOX 747, FALLS CHURCH, VA, 22040-0747, US

(21) Appl. No.: 10/076,384

(22) Filed: Feb. 19, 2002

(30) Foreign Application Priority Data
Feb. 16, 2001 (JP) 2001-039678

(51) Int. Cl. H04N 7/14; H04N 7/00; H04N 7/18; H04N 9/47

(52) U.S. Cl. 348/116; 348/14.01; 348/113; 348/143

(57) ABSTRACT

The information transmitting system includes a camera by which a message sending photographer allocates message information to a subject specified in a picture being taken and which has a capability of acquiring information about a position of a shooting site and information about a shooting direction; a subject identifying unit which identifies the subject by deducing a geographical position of the subject using the information about the shooting position and direction, and optionally a position of the subject which is within the picture taken; and a message information transmitting unit which transmits the message information to the subject or a specified object including a third party. Information can be easily transmitted among a desired number of members and communication of information with objects at long distance is possible. If desired, advertisements or comments may be conferred to a specified subject and the information they carry may be displayed to any persons.

### BACKGROUND OF THE INVENTION

This invention relates to an information transmitting system, more particularly, to an information transmitting system which allocates message to an image of a subject (a subject's picture) taken with a camera so that information can be transmitted to the subject or a desired member (third party).

With the recent advances in GPS (global positioning system) using communication satellites, the use of the car navigation system is increasing. Upon receiving radio waves from satellites, the car navigation system performs a position measurement, corrects the error from the result of dead reckoning navigation in the receiver unit, performs map matching using the mapping data typically stored in CD-ROM, and displays the current position of the vehicle on the display.

Latest models of the car navigation system have more capabilities and can not only display the current position of the vehicle but also present, where appropriate, traffic information such as about traffic jam and information about sight-seeing spots and various kinds of facilities. Today's car navigation systems can do more than presenting the location on a 2D map, they can display the same scene as the driver behind the steering wheel is seeing.

In photography, image reproducing methods have been proposed that prepare photographic prints by capturing position information by GPS and further adding related information. According to the image reproducing method disclosed in a 2000-66312 A, a picture is taken by the combination of satellite-based GPS with an APS (advanced photo system) compatible camera equipped with a bearing indicator for direction finder and the latitude, longitude and altitude for the shooting location, as well as the shooting azimuth angle to the horizontal and vertical planes and other necessary information are recorded on the magnetic recording layer of a film; during image processing, those pieces of shooting information are acquired from the film and a mapping database is referenced to specify the subject in the picture taken and the location of shooting, and additional information related to the subject (subject-related information) is composited with the image to prepare a photographic print which is subsequently output.

This prior art technology, however, has had a problem that ordinary users can only acquire and use information but have no option to send user-related information (e.g. message) to the initial sender of the information or a desired member (third party), nor is it possible for subject-related information to be transferred from one desired member to another and vice versa.

### SUMMARY OF THE INVENTION

The present invention has been accomplished under these circumstances and has as an object providing an information transmitting system which not only allows a photographer to transmit message information to a specified subject in an image (a picture) taken but which also permits information to be easily transmitted between the photographer and a desired member including a third party with the intermediary of photographic shooting.

In order to attain the object described above, the first aspect of the present invention provides an information transmitting system comprising: a first camera by means of which a photographer who sends a message allocates message information to a subject specified in a first picture (image) being taken and which also has a capability of acquiring information about a position of a shooting site and information about a shooting direction; a subject identifying unit which identifies the subject by deducing a geographical position of the subject using the information about the position of the shooting site and the information about the shooting direction that have been acquired by the first camera or the information about the position, the information about the shooting direction and a position of the subject which is within the first picture taken; and a message information transmitting unit which transmits the message information to the subject or a specified object including a third party.

Preferably, the message transmitting unit notifies the subject that the message information from the photographer who sends the message is present and transmits the message information to the subject in response to access by the notified subject.

It is preferable that the information transmitting system further includes a message information allocating unit which deduces a spatial position in which the message information from the photographer who sends the message is to be allocated to the identified subject and which allocates the message information in the spatial position, wherein upon access by the specified object including the third party who takes or watches a second picture containing the spatial position corresponding to the subject, the message information transmitting unit transmits to the specified object the message information which was allocated in the spatial position on the first picture taken by the photographer.

Preferably, the message information is displayed as assembled on the second picture taken or watched by the specified object including the third party with a second camera or a watching device to which the message information is transmitted, in a position corresponding to the spatial position of the first picture taken by the photographer.

In order to attain the object described above, the second aspect of the present invention provides an information transmitting system comprising: a first camera having a message display mode which allows a message sending photographer to display message information in a specified area of a first picture (image) being taken, and which allocates the message information to the specified area of the first picture taken and acquires information about a position of a shooting site and information about a shooting direction; a detector which detects that the first camera is in the message display mode; a message information allocating unit which, when the first camera is in the message display mode, uses the information about the position of the shooting site and the information about the shooting direction that have been acquired by the first camera, or the position information and the information about the shooting direction in combination with information about a distance from the first camera to thereby deduce a specified spatial position in the picture taken to which the message information is to be allocated, and allocates the message information in the spatial position; and a message information transmitting unit which transmits the message information to a specified object including a third party; wherein if the specified object including the third party designates the message display mode in a second camera which has a capability of acquiring the information about the position of the shooting site and the information about the shooting direction or in a watching device which has a capability of acquiring information about a position of a watching site and information about a watching direction, takes or watches a second picture (image) with the second camera or the watching device at a view angle including a spatial position corresponding to the spatial position on the first picture taken by the photographer, and then accesses the message information transmitting unit, the message information transmitting unit transmits the message information to the specified object in order that the message information is displayed as assembled at the spatial position in the second picture taken or watched by the specified object.

Preferably, the specified area or spatial position to which the message information is to be allocated is designated by numerical data on latitude and longitude information or latitude, longitude and altitude information.

Preferably, the specified area or spatial position to which the message information is to be allocated is designated by their place name or proper name, if necessary in combination with altitude information.

It is preferable that, in the first and second aspects, display contents and/or display format of the second picture taken or watched and/or the message information which are displayed as assembled are controlled depending on situation of the specified object, the subject or the photographer, or are controlled depending on moving situation of the first camera, the second camera or the watching device.

Preferably, the first picture or the second picture taken or watched is a moving image, and display contents and/or display format of the second picture taken or watched and/or the message information which are displayed as assembled are controlled depending on movement of the second picture of the moving image.

Preferably, the first picture or the second picture taken or watched is a moving image, and an image reproducing speed of the second picture taken or watched and/or the message information which are displayed as assembled is controlled depending on an amount of the message information.

Preferably, the specified object or the subject registers a category of the message information to be transmitted to the message information transmitting unit, and the message information transmitting unit transmits only the message information coincident with the registered category to the specified object or the subject.

Preferably, the specified object or the photographer transmits present situation information of one's own self to the message information transmitting unit, and the message information transmitting unit transmits the message information which is controlled depending on the present situation information to the specified object or the subject.

Preferably, the specified object or the photographer transmits present situation information of one's own self to destination designated by one's own self, the message information transmitting unit transmits the message information to the designated destination of one's own self, and the designated destination of one's own self processes the message information depending on the present situation information and transmits the processed message information to the specified object or the subject.

### BRIEF DESCRIPTION OF THE DRAWINGS

FIG. 1 is a diagram showing an outline of an information transmitting system according to a first embodiment of the invention;

FIG. 2 is a diagram showing an outline of an information transmitting system according to a second embodiment of the invention;

FIG. 3 is a diagram showing an outline of an information transmitting system according to a third embodiment of the invention; an image display of the information transmitting system of the invention;

FIG. 4B is a diagram showing another exemplary picture on the image display of the information transmitting system of the invention;

FIG. 5 is a diagram showing an outline of a modification of the embodiments of the information transmitting system of the invention;

FIG. 6 is a diagram showing an outline of another modification of the embodiments of the information transmitting system of the invention; and

FIG. 7 is a diagram showing an outline of still another modification of the embodiments of the information transmitting system of the invention.

### DETAILED DESCRIPTION OF THE INVENTION

The information transmitting system of the invention is described below in detail with reference to the preferred embodiments shown in the accompanying drawings.

To begin with, we describe a first embodiment of the invention.

In the first embodiment of the invention, a photographer who is going to send a message (hereunder referred to as a message sender) takes a picture (an image) of a subject with a camera that has a capability of acquiring the position information about the location of shooting and the information about the direction of shooting (for example, a camera with a GPS receiver unit and an azimuth angle sensor) and which also has a capability of adding a message to the taken picture (image); the camera acquires the position information about the location of shooting and the information about the direction of shooting while at the same time allocating, assigning or adding message information to the specified subject in the picture; these pieces of information are sent together with the camera identifying information to a database organization, which then deduces the geographical position of the subject from the position information about the shooting location and the information about the shooting direction, identifies the subject and notifies the subject of the presence of the message information; being thereafter accessed by the subject, the database organization transmits the message information to the subject, so that the message information from the message sender is transferred to the subject. Alternatively, the database organization may directly send the message information to the subject.

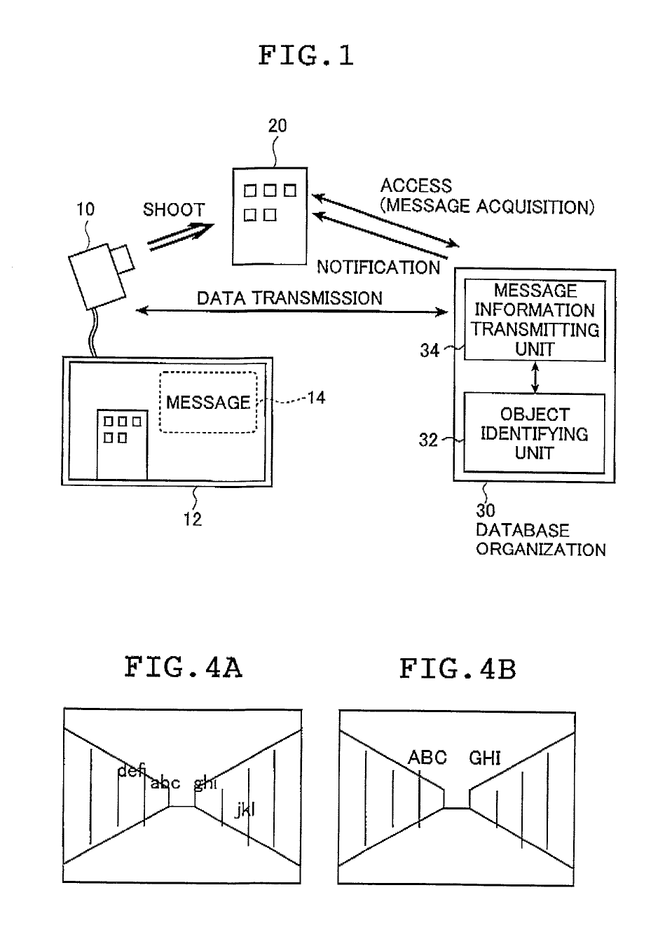

FIG. 1 is a diagram showing an outline of an information transmitting system according to the first embodiment of the invention. As shown, the information transmitting system according to the first embodiment of the invention comprises a message sender's camera 10, an subject 20 such as a building, an advertising tower or a billboard of a company, or any other structure which is to be photographed with the camera 10, and a database organization 30 in which are registered mapping information for deducing the geographical position of the subject 20 and data about client companies and which is an intermediary for the message information from the message sender to be transferred to the subject 20.

The camera 10 is a digital camera having both a GPS receiver unit and an azimuth angle sensor and can acquire position information including information about the latitude, longitude and altitude of the shooting location, as well as information about the shooting direction typically represented by the angle from magnetic north.

The camera 10 also has a data transmitting capability and while photographing the subject 20, it may communicate with the database organization 30 to acquire information about the subject 20.

Usually, the subject 20 is a company and under contract with the database organization 30, information about its name, financial status, activities, services, questionnaire, recruitment of new employees and the goods it handles as well as various other pieces of information about the company are registered in the database organization 30. When the message sender photographs the subject 20 with the camera 10, the camera 10 may access (make an inquiry to) the database organization 30 and in response to this inquiry, information about the subject 20 is sent from the database organization 30 to the camera 10.

Having thus acquired information about the subject 20, the camera 10 displays the acquired information on the image display 12 of the camera 10. This is not the sole case of the invention and information about various subjects may be preliminarily loaded in the UPS software in the camera 10 so that information about a specific subject can be directly retrieved without access to the database organization 30 and displayed automatically.

The camera 10 also has a capability of allocating message information to a desired subject in the picture it takes. By pen or other input means applied to the image display 12 on the camera 10, the message sender may designate a position 14 in the picture being or having been photographed where message information is to be allocated to the subject and the sender then inputs message information.

The message information to be sent from the camera 10 is not particularly limited as long as the message sender wants to send to the subject 20 and may include inquiry information about the financial status or the like of a company as the subject 20 and inquiry information about its services, recruitment and the goods It handles, as well as order or application information.

The database organization 30 is an intermediary by which the message information from the message sender is transferred to the subject to which the message sender wants to send the message information. The database organization 30 has a subject identifying unit 32 which identifies the subject and keys it to the message information and a message information transmitting unit 34 which transmits the message information to the identified subject.

Using the position information about the shooting location and the information about the shooting direction which have been sent from the camera 10 to the database organization 30 together with the camera identifying information, the subject identifying unit 32 deduces the geographical position of the subject 20, calculates the similarity between the deduced position information and the registered position information about the subject (Client) 20, and identifies the subject 20 (as, for example, company X).

Ideally, the subject is positioned in the center of the picture taken. Irrespective of the magnification used in shooting, one only needs to search over the mapping data for the subject lying on the straight line along the optical axis of the camera and this assures a sufficiently accurate decision. If the subject is offset from the picture taken, the data about the magnification must also be transmitted to the database organization.

If the data about the picture taken is also sent from the camera 10 to permit the use of the position of the subject in the picture taken, the geographical position of the subject can be deduced more accurately by combining the aforementioned shooting direction with the view angle, focal length, magnification and other relevant factors. For the method by which the picture taken is transmitted as such to the database organization which then identifies the subject, the method disclosed in, for example, JP 2000-66312 A is applicable.

The message information transmitting unit 34 allocates the message information to the thus identified subject 20, notifies the registered place of contact with the subject 20 that it has received the message information, and transmits the message information to the subject 20 in response to an access made by the subject 20.

If desired, the message information transmitting unit 34 may directly transmit the message information to the subject 20 without notifying its receipt.

The mode of operation of the first embodiment is described below.

In the first step, the message sender takes a picture of the real space with the camera 10 equipped with a GPS receiver unit and an azimuth angle sensor (compass). Suppose here that the subject 20 is included in the picture taken.

The message sender as a photographer which is looking at a billboard on the subject 20 recognizes that the subject 20 is a certain company and wants to purchase an item being sold by the company. He selects a desired position (subject 20) in the picture by means of an electronic pen or other input device that is applied to the image display 12 on the camera 12; he then designates a message information allocating position 14 and writes message information about the order or the like into that position. The message information is not limited to textual information; it may be an image (e.g. moving or still image or a 3D image); if the camera 10 is compatible with input by voice, the message information may be voice data.

In the next step, the information about the shooting position and direction, as well as the message information written to the subject 20 are sent from the camera 10 to the database organization 30. By means of the subject identifying unit 32, the database organization 30 deduces the geographical position information (numerical data on latitude, longitude and altitude) about the subject 20 in accordance with the information sent from the camera 10, i.e., the information about the shooting position and direction and, optionally, the position of the subject in the picture taken. The geographical position information need not be deduced by the database organization 30 but by the camera 10; in this alternative case, the information about the result of deduction is sent from the camera 10 to the database organization 30 together with the message information.

In the next step, the subject identifying unit 32 in the database organization 30 calculates the similarity between the thus deduced position information about the subject 20 and the client's position information already registered in the database and identifies the subject 20 on the basis of the result of calculation.

If desired, the image of the subject 20 may be registered in the database, in this case, the data for the image taken as well as the message information is sent from the camera 10 and pattern matching is effected between images to identify the subject 20. Language description (description of the subject by language) is another type of information that can be used to identify the subject 20. For example, if RED SIGN FOUND is registered as keywords, the subject identifying unit 32 may search through the read area of the picture to identify the subject and allocate the real space 3D position data.

The subject 20 is not limited to still objects such as the building mentioned in the foregoing description and moving objects are also applicable. Exemplary moving objects include a person and structures such as an automobile (passenger car, truck or bus), a train, an aircraft, an airship and a ship. If the subject 20 is moving, it is responsible for constantly updating the position data and incorporating time information into the information about its position. The moving object must communicate the set of position information and time information to the database organization. In this case, the message sender must transmit the data on the shooting date and time to the database organization.

Astral bodies such as the moon and stars may be included in the moving object of the invention from the viewpoint that their positions vary with time on the basis of the Earth's surface. However, when such an astral body of which the position can be previously determined by calculation is the moving objects the database organization does not need to receive the movement information (position, date and time) from the moving object unlike the structures mentioned above.

When the subject 20 is identified, the message information transmitting unit 34 notifies the place of contact with the identified subject 20 that it has received the message information

Being notified of the receipt of the message information, the subject 20 accesses the database organization 30r whereupon the message information transmitting unit 34 in the database organization 30 transmits the message information to the subject 20. As already mentioned, the message information transmitting unit 34 may directly transmit the message information to the subject 20 without informing the subject 20 of the receipt of the message information.

In this way, the message information from the message sender has been transmitted to the subject 20. If desired, the information about the subject 20 already registered in the database organization may be transmitted to the message sender's camera 10 at the time when the subject has been identified.

Thus, in the first embodiment of the invention, the message sender does not simply receive and make use of the information as from GPS, it can also transmit a message for an inquiry, an order or an application to the subject; in other words, two-way communication can be easily accomplished.

We now describe a second embodiment of the invention.

The second embodiment is the same as the first embodiment in that the message sender takes a picture of the subject and allocates message information to the subject. The difference is that when a third party for example in an arbitrary number of members takes a picture of the same subject with a camera or watches the same subject with a watching device such as a pair of binoculars, the message information allocated to the subject is composited with the picture taken with the camera or watched in the watching device such that the third party can acquire the message information from the message sender, which ensures that information can be easily transmitted among an arbitrary number of members.

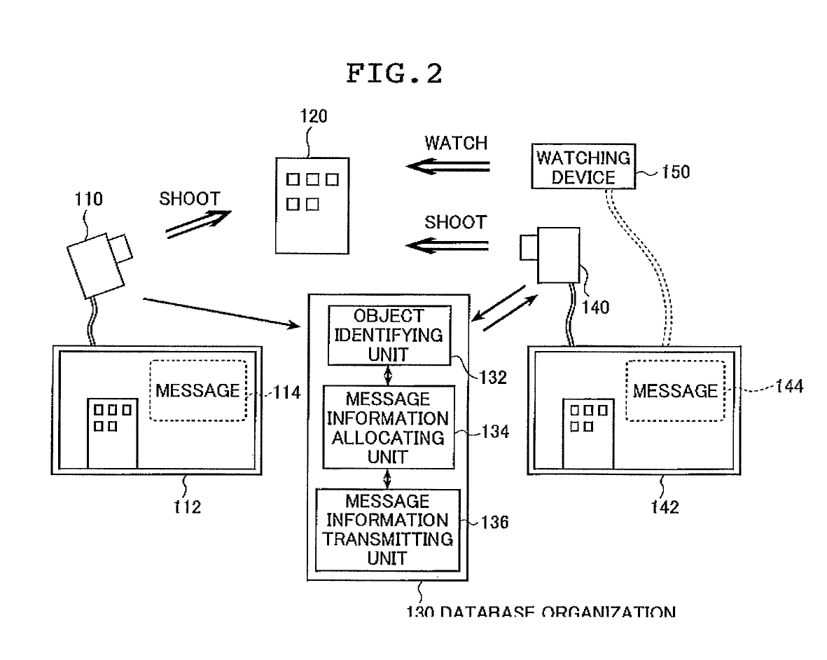

FIG. 2 shows an outline of an information transmitting system according to the second embodiment.

As FIG. 2 shows, the information transmitting system according to the second embodiment comprises a message sender's (or photographer's) camera 110, a subject 120 and a database organization 130, as well as a camera 140 and/or a watching device 150 of a third party who wants to acquire the message information from the message sender. The camera 140 of the third party also has a capability of acquiring the information about the shooting position and direction, that is, the position information about the shooting location and the information about the shooting direction. The watching device 150 of the third party also has a capability of acquiring the position information about the watching location and the information about the watching direction. In other words, the camera 140 and the watching device 150 need only have a capability which enables the third party to read the message. Therefore, the capability of acquiring the position information and the direction information is essential, whereas the capability of writing message is not.

The message sender, when taking a picture of the subject 120 with the camera 110, operates on the image display 112 of the camera 110 to designate a specified area 114 in the screen using the subject 120 as a position marker. The area 114 is where the message information is to be allocated. The message sender then writes the message information into the designated area 114. After the picture of the subject is taken, the relevant shooting information (camera information) and the message information are transmitted from the camera 110 to the database organization 130 together with the camera identifying information.

The database organization 130 includes a subject identifying unit 132, a message information allocating unit 134 and a message information transmitting unit 136.

The subject identifying unit 132 identifies the subject 120 in the same way as in the first embodiment. In accordance with the geographical position of the identified subject 120, the message information allocating unit 134 deduces the spatial position where the message information is to be allocated and allocates the message information to the deduced spatial position. When a third party takes a picture of an area including the same subject 120 with the camera 140 or watches this area with the watching device 150 and then accesses the database organization 130, the message information transmitting unit 136 assembles the message information in the spatial position corresponding to the same subject 120 in the picture taken by the third party's camera 140 or watched in the watching device 150. When the third party accesses the database organization 130, the information about the shooting position and direction is transmitted from the third party's camera 140 together with the camera identifying information, or the information about the watching position and direction is transmitted from the third party's watching device 150 together with the identifying information of the watching device 150. Further, the database organization 130 is not the sole entity which is responsible for this process of image composition. It may be responsible for transmitting only the message information and the information about the spatial position where the message information is to be assembled, or alternatively only the information about the position in the picture on the image display 142 of the camera 140 or the watching device 150 may be transmitted by the database organization 130; in this case, image composition is performed by the camera 140 or the watching device 150. If the database organization 130 is to perform synthesis of the message, it shall transmit and receive the picture taken or watched by the third party.

If the message information is a 3D image, the image to be displayed for synthesis may be created in accordance with the viewing direction which depends on the direction in which the third party takes a picture of the subject 120. In this case, the 3D image may be processed by the database organization 130 using computer graphics (CG) techniques; alternatively, if the third party's camera 140 or watching device 150 has equivalent capabilities, the camera 140 or the watching device 150 may process the 3D image.

In this way, the third party takes a picture of the same subject 120 as taken by the message sender with the camera 140 or watches the same subject 120 with the watching device 150 and the message information from the message sender is displayed as assembled in the specified position 144 on the image display 142 of the third party's camera 140 or watching device 150. Thus, the third party who takes a picture of the area of the subject 120 or watches this area finds it possible to acquire the message sent (written) by the message sender.

As a modification of the second embodiment in which the third party photographs or watches the subject 120, the system may be so designed that the message is presented as assembled in the picture of the subject 120 photographed or watched by the third party only when the subject 120 is photographed or watched in the same position or direction as the message sender took the picture of the subject 120.

Although the message is not actually written (not real) in the area of the subject 120, the message comes out as assembled in the picture of the area taken or watched by the third party. In this sense, the specified subject can be used as a so-called virtual message board to or from which information can he written or read.

If there is a password that must be supplied by the third party to access the database organization 130, information can be easily transmitted among privileged members of a particular group

If the message information from a plurality of information senders is allocated to the same spatial position, more than one person can write information at the same time. Alternatively, an available space may be provided at given time intervals so that a plurality of persons can use it by turns.

As described above, communication of information to objects at long distance or a plurality of objects such as office buildings and persons can be easily accomplished in the second embodiment. If message such as ads and comments are allocated to a specified subject, each time the third party photographs or watches the subject, the ad is displayed and the subject has great commercial benefits since the advertising effect is increased without installing actual displays such as signs on the office building.

We now describe a third embodiment of the invention.

The third embodiment is generally the same as the second embodiment as mentioned above. The difference is that in the second embodiment, message information is transmitted by writing and reading it using a specified subject as a position marker whereas in the third embodiment, such marker subject is not essential and the camera or the watching device may be pointed to the background, for example, the sky for photographing or watching, and message information is written in the sky as if it were a message board.

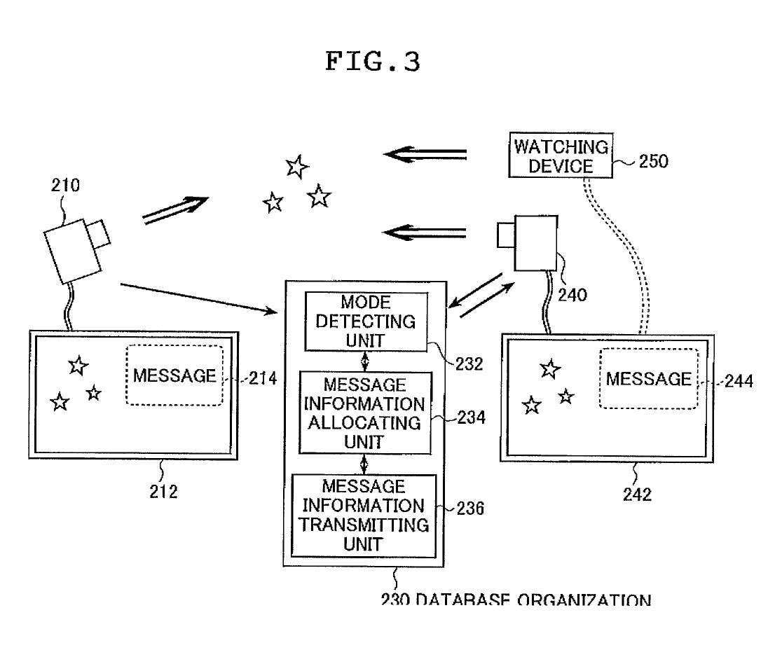

FIG. 3 shows an outline for the information transmitting system according to the third embodiment. As is clear from FIG. 3, the information transmitting system of the third embodiment comprises a message sender's camera 210, a database organization 230 and a third party's camera 240 and/or watching device 250. In the third embodiment under consideration, there is no subject that can be used as a position marker for allocating the message information. Instead, the cameras 210 and 240 and the watching device 250 have a message display mode in which they designate a mode for displaying the message information on a picture taken by the cameras 210 and 240 or watched in the watching device 250.

As in the second embodiment, both of the cameras 210 and 240 have a capability of acquiring the information about the shooting position and direction, whereas the watching device 250 has a capability of acquiring the information about the watching position and direction.

The message sender first designates the message display mode with the camera 210. He then points the camera 210 to the background, say, the sky and optionally designates the distance from the camera. In the next step, he designates a message information allocating position 214 on the image display 212, writes message information in that position and takes a picture. If the distance from the camera is not designated, the space into which the message is to be allocated is regarded as an infinitely distant point. After shooting, the relevant information (position and direction of the camera 210, distance from the camera 210, message, message display mode and so forth) is transmitted to the database organization 230 together with the identifying information of the camera 210. The database organization 230 comprises a mode detecting unit 232, a message information allocating unit 234 and a message information transmitting unit 236. The mode detecting unit 232 detects a message display mode on the basis of the information sent from the camera 210.

If the message display mode is detected, the spatial position where the message information is to be displayed is deduced within the picture taken, by means of the message information allocating unit 234 on the basis of the position information about the site of shooting by the message sender and the direction information and, optionally, from the distance information if this is designated, and the message information from the message sender is allocated in the deduced spatial position.

The third party also designates the message display mode with the camera 240. He then points the camera 240 or the watching device 250 to the sky for shooting or watching and accesses the database organization 230. During this process, the information about the camera or the watching device (i.e., position, direction, message display mode and the like of the camera 240 or the watching device 250) is transmitted to the database organization 230 together with the identifying information of the camera 240 or the watching device 250. Then, the mode detecting unit 232 of the database organization 230 detects the message display mode. On the basis of the information about the shooting position and direction or watching position and direction sent from the third party's camera 240 or watching device 250, the message information allocating unit 234 confirms that the deduced spatial position is included in the picture taken or watched and the message information allocated to the deduced spatial position is transmitted to the third party's camera 240 or watching device 250 from the message information transmitting unit 236.

Receiving the message information, the third party's camera 240 or watching device 250 presents the message information as assembled on an image display 242 at a message display position 244. If the message sender displays a message on a picture of a starry sky as shown in FIG. 3, the same message is displayed on the picture of the same starry sky taken or watched by the third party and thus the message is transmitted.

Synthesis of the message information may be performed on the side of the camera 240 and the watching device 250 or on the side of the database organization 230. If the database organization 230 is responsible for message synthesis, it shall transmit and receive the picture taken or watched by the third party. As in the second embodiment, the third party may access the database organization 230 by supplying a password or a plurality of persons may be privileged to simultaneously write or read the message to or from the same spatial position.

As described above, it is possible in the third embodiment to have the message information transmitted between two cameras or between a camera and a watching device via the database organization.

Thus, an advantage of the third embodiment is that message information can be easily transmitted among a desired number of members using a virtual display space (spatial position) as if it were a message board. The transmitted message information is reproduced as appropriate for its type, e.g. whether it is a still image, a moving image, a text or voice. Another advantage of using the information transmitting system of the third embodiment is that it enables placing orders for printing composite images, recording them to a specified recording medium and transferring them to a predetermined place of contact over the net in this case, data may be transmitted either from the third party himself or from the database organization on his order.

The subject or the spatial position to which message information should be allocated may be designated in different manners than described in connection with the second and third embodiments. If the longitude, latitude and altitude of said subject or spatial position are already known, said subject or spatial position may be designated in terms of the numerical data for the longitude and latitude, or longitude, latitude and altitude. Alternatively, the subject to which the message information should be allocated may be designated by its place name or proper name, optionally together with the altitude information. For instance, the members of a certain group may find it easy to exchange messages among themselves on a message board that is created by designating a well-known subject or spatial position that is common to all members.

In the first to third embodiments as described above, the message senders photographing the subjects 20, 120 and a subject space (for instance, the sky in FIG. 3) with the cameras 10, 110 and 210, respectively, the third parties (photographers) photographing subjects with the cameras 140 and 240, and the third parties (watchers) watching subjects with the watching devices 150 and 250 are not limited to those who photograph or watch subjects while staying at a shooting or watching site. The users of the cameras 10, 110, 210, 140 and 240 or the watching devices 150 and 250 (message senders and third parties) may also photograph or watch subjects while moving- In other words, according to the present invention, display contents and/or display format may be controlled depending on the situation of the users such as the third parties, the subjects, or the message senders.

When the user is moving, it is preferred to control display contents and/or display format of a photographed or watched image and message information (related information), which are to be displayed on the image display 12, 112, 142, 212 or 242, depending on the user's situation.

For example, when the user is moving by a mobile unit such as automobile, train, aircraft and ship, it is preferred to control display items, display size, display color, display region, display time or the like depending on the moving speed of the user. Specifically, if the moving speed is higher, it is preferable to carry out at least one of those controls in which the number of display items is decreased, a larger display size is selected, a display color is changed, the display region is reduced by narrowing the viewing angle toward the center of screen, and periodic display is realized, as compared with the case with a lower moving speed. As a result of such controls, the related information displayed becomes more legible to the user. On the occasion when the user is the driver or operator of a mobile unit, in particular, such controls as above except for periodic display, as improving the viewability of display, will prevent the user from inattentiveness and so on to contribute the traffic safety.

In the first to third embodiments as described above, it is preferred to control display contents and/or display format of an image and information to be displayed depending on the moving situation of the cameras and the watching devices, also when zooming or panning is performed with the cameras 10, 110, 210, 140 and 240 and the watching devices 150 and 250. That is to say, it is preferred to control display items, display sizer display color, display region or the like, as is the case with the moving user as described above, depending this time on the zooming or panning speed. For example, if the speed is higher, it is preferable to display an image and information as shown in FIG. 4B, carrying out controls in which the number of display items is decreased, a larger display size is selected, a display color is changed, and the display region is reduced by narrowing the viewing angle toward the center of screen as compared with the case with a lower speed, which is shown in FIG. 4A. The viewability of display will thus be improved.

In the first to third embodiments as described above, if the message information is a moving image, or again, if the subjects 20, 120 and the subjects (subject spaces) photographed by the cameras 210 or 240, or watched by the watching devices 25 are moving and a photographed or watched image is a moving image, it is preferred to take such measures as follows when a moving image once recorded is reproduced to display at a normal or high speed on the image display 12, 112, 142, 212 or 242.

First of all, it is preferred to control display items, display size, display color, display region or the like, as is the case with the moving user as described above, depending this time on the movement (of the displayed picture) in the display screen or the image-reproducing speed. For example, it is preferable to decrease the number of display items, select a larger display size, change a display color, and reduce the display region by narrowing the viewing angle toward the center of screen as the movement in the screen gets more extensive or rapid.

It is also preferable to control the image-reproducing speed depending on the amount of related information such as message information contrary to the case as referred to above. For example, if the items or characters to be displayed are larger in number, it is preferable to decrease the image-reproducing speed to reproduce an image more slowly.

As a consequence, the viewability of display will be improved.

In the first to third embodiments as described above, the user (client) of the information transmitting system of the present invention is preferably able to register a request of the client's own at the service center providing the service of the information transmitting system of the present invention (or its database organization, specifically, the message information transmitting units 34, 136 and 236). In that case, the client can register, for example, the category of the information which the client wants to acquire It is also possible to designate a given item based on the time or location or at a given timing instead of the registration of such a category.

The above registration or designation allows the client to be served with only the information belonging to the category coincident with the registered category, or the information on the item coincident with the registered item, that is, the information (including advertisement) belonging to the intended category, or again, the information (including advertisement) on the intended item for a given period of time, at a given location, or at a given timing and display the information thus obtained.

Moreover, even if one and the same point has been viewed, that is to say, one and the same subject has been photographed or watched by a plurality of clients, different information (including advertisement) can be displayed for different clients (persons) as a result of optimization for each client.

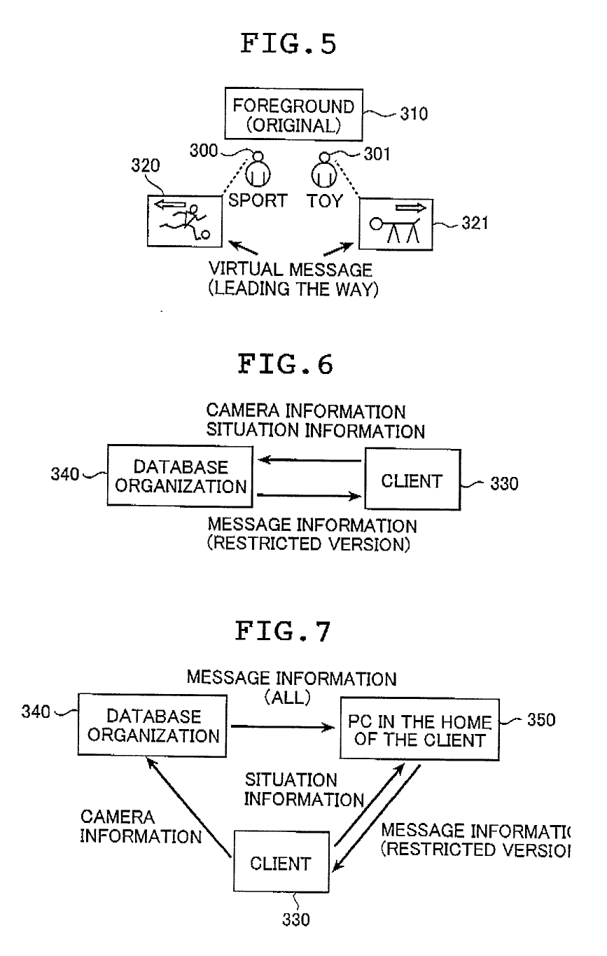

An example of such a case is shown in FIG. 5. Assume that there are two clients 300 and 301 (each as a message sender or photographer or watcher), the client 300 wanting to acquire information about sport and the client 301 to acquire information about toy, and these categories of information have already been registered at the service center (not shown). When the clients 300 and 301 photograph or watch a subject (its foreground) 310 with a camera or watching device (not shown), an image associated with sport and its direction and an image associated with toy and its direction can be displayed on the screens 320 and 321 of the image displays of the clients 300 and 301, respectively.

In the first to third embodiments as described above, in addition to the information about the camera or watching device of the client, information about the present situation of the client him/herself (client's own self) may be transmitted to the database organization and then the message information may be controlled in the database organization according to the situation information from the client.

Specifically, as shown in FIG. 6, the information indicating the present situation of the client as well as the identification information of the client (identification information of the client himself, his camera, or his watching device), the shooting or watching position information, and the viewing direction information (shooting or watching direction information, namely information on the direction of the optical axis of the camera or watching device) are transmitted from an equipment 330 such as camera and watching device, which the client carries, to a database organization 340.

Then, in the database organization 340, the message information to be sent back is controlled according to the situation information from the client by, for example, subjecting the message information to a restriction processing and the controlled message information (message information of the restricted version) is sent back to the equipment 330 of the client.

If the client is moving as described before, for example, controlling depending on the moving speed of the client is preferred. If the request of the client (the intended category of information, or the item designated based on the time or location) has been registered at the database organization 340, controlling corresponding to the client's objective point or category of interest is preferred.

In this way, the amount of information to be transmitted is made smaller. Consequently, the load, the memory capacity needed, or a processing for specifying the information to be displayed can be reduced in the equipment (or terminal device) of the client.

In that case, it is also possible to transmit the message information before processing in whole to a destination (a personal computer in a home, for example) designated by the client, which is not shown, for the subsequent confirmation by the client.

An example of such a case is shown in FIG. 7. First, the equipment 330 of the client transmits the information about camera or watching device to the database organization 340.

Second, the database organization 340 transmits the message information in whole to a destination designated by the client (client's own self) a personal computer (PC) 350 in the home of the client, for example. Preferably, the destination designated by the client is previously registered at the database organization 340.

To the PC 350 in the home as the destination designated by the client, the information about the client's situation is also transmitted from the equipment 330 of the client.

The PC 350 in the home executes processing of the message information such as a revision or restriction processing, for instance, according to the situation information from the client and transmits the processed message information (the restricted version) to the equipment 330 of the client.

In this way, the load on the database organization 340 can be reduced and in addition the client can customize the message information of the restricted version for himself.

Storing the message information in whole in the PC 350 in the home also enables the client to confirm the message information in whole after receiving the processed message information as the restricted version on the equipment 330.

In the first to third embodiments as described above, the cameras 10, 110 and 210 used by the message senders may be of similar type to one another and again the subjects 20, 120 and the subject space (the subject photographed with cameras 210 and 240 or watched with the watching devices 250) may be of similar type to each other. This is also the case with the cameras 140 and 240 or the watching devices 150 and 250 of the third parties.

While the information transmitting system of the invention has been described above in detail with reference to various embodiments, it should be understood that the invention is by no means limited to the foregoing embodiments and that various improvements and modifications are possible without departing from the spirit and scope of the invention.

As described on the foregoing pages, the invention allows information to be easily transmitted among a desired number of members. In particular, it enables information to be communicated with objects at long distance, if desired, ads or comments may be conferred to a specified subject and the information they carry may be displayed to any persons.

What is claimed is:

1. An information transmitting system comprising:
a first camera by means of which a photographer who sends a message allocates message information to a subject specified in a first picture being taken and which also has a capability of acquiring information about a position of a shooting site and information about a shooting direction;
a subject identifying unit which identifies said subject by deducing a geographical position of said subject using the information about the position of the shooting site and the information about the shooting direction that have been acquired by said first camera or the information about the positions the information about the shooting direction and a position of said subject which is within the first picture taken; and
a message information transmitting unit which transmits said message information to said subject or a specified object including a third party.

2. The information transmitting system according to claim 1, wherein said message transmitting unit notifies said subject that the message information from said photographer who sends the message is present and transmits said message information to said subject in response to access by said notified subject.

3. The information transmitting system according to claim 1, further including a message information allocating unit which deduces a spatial position in which the message information from said photographer who sends the message is to be allocated to said identified subject and which allocates said message information in said spatial position,
wherein upon access by said specified object including the third party who takes or watches a second picture containing said spatial position corresponding to said subject, said message information transmitting unit transmits to said specified object said message information which was allocated in said spatial position on said first picture taken by the photographer.

4. The information transmitting system according to claim 3, wherein said message information is displayed as assembled on said second picture taken or watched by said specified object including the third party with a second camera or a watching device to which said message information is transmitted, in a position corresponding to the spatial position of the first picture taken by the photographer.

5. The information transmitting system according to claim 4, wherein display contents and/or display format of said second picture taken or watched and/or said message information which are displayed as assembled are controlled depending on situation of said specified object, said subject or said photographer.

6. The information transmitting system according to claim 4, wherein display contents and/or display format of said second picture taken or watched and/or said message information which are displayed as assembled are controlled depending on moving situation of said first camera, said second camera or said watching device.

7. The information transmitting system according to claim 4, wherein said first picture or said second picture taken or watched is a moving image, and display contents and/or display format of said second picture taken or watched and/or said message information which are displayed as assembled are controlled depending on movement of the second picture of said moving image.

8. The information transmitting system according to claim 4, wherein said first picture or said second picture taken or watched is a moving imager and an image-reproducing speed of said second picture taken or watched and/or said message information which are displayed as assembled is controlled depending on an amount of said message information.

9. The information transmitting system according to claim 1, wherein said specified object or said subject registers a category of said message information to be transmitted to said message information transmitting unit, and said message information transmitting unit transmits only the message information coincident with said registered category to said specified object or said subject.

10. The information transmitting system according to claim 1, wherein said specified object or said photographer transmits present situation information of one's own self to said message information transmitting unit, and said message information transmitting unit transmits the message information which is controlled depending on said present situation information to said specified object or said subject.

11. The information transmitting system according to claim 1, wherein said specified object or said photographer transmits present situation information of one's own self to destination designated by one's own self, said message information transmitting unit transmits said message information to said designated destination of one's own self, and said designated destination of one's own self processes said message information depending on said present situation information and transmits said processed message information to said specified object or said subject.

12. An information transmitting system comprising:
a first camera having a message display mode which allows a message sending photographer to display message information in a specified area of a first picture being taken, and which allocates the message information to the specified area of the first picture taken and acquires information on about a position of a shooting site and information about a shooting direction;
a detector which detects that said first camera is in said message display mode;
a message information allocating unit which, when said first camera is in said message display mode, uses the information about the position of the shooting site and the information about the shooting direction that have been acquired by said first camera, or said position information and said information about the shooting direction in combination with information about a distance from the first camera to thereby deduce a specified spatial position in said picture taken to which said message information is to be allocated, and allocates said message information in said spatial position; and
a message information transmitting unit which transmits said message information to a specified object including a third party;
wherein if said specified object including the third party designates the message display mode in a second camera which has a capability of acquiring the information about the position of the shooting site and the information about the shooting direction or in a watching device which has a capability of acquiring information about a position of a watching site and information about a watching direction, takes or watches a second picture with said second camera or said watching device at a view angle including a spatial position corresponding to said spatial position on the first picture taken by the photographer, and then accesses said message information transmitting unit, said message information transmitting unit transmits said message information to said specified object in order that said message information is displayed as assembled at the spatial position in the second picture taken or watched by said specified object.

13. The information transmitting system according to claim 12, wherein the specified area or spatial position to which said message information is to be allocated is designated by numerical data on latitude and longitude information or latitude, longitude and altitude information.

14. The information transmitting system according to claim 12, wherein the specified area or spatial position to which said message information is to be allocated is designated by their place name or proper name, if necessary in combination with altitude information.

15. The information transmitting system according to claim 12, wherein display contents and/or display format of said second picture taken or watched and/or said message information which are displayed as assembled are controlled depending on situation of said specified object or said photographer.

16. The information transmitting system according to claim 12, wherein display contents and/or display format of said second picture taken or watched and/or said message information which are displayed as assembled are controlled depending on moving situation of said first camera, said second camera or said watching device.

17. The information transmitting system according to claim 12, wherein said first picture or said second picture taken or watched is a moving image, and display contents and/or display format of said second picture taken or watched and/or said message information which are displayed as assembled are controlled depending on movement of the second picture of said moving image.

18. The information transmitting system according to claim 12, wherein said first picture or said second picture taken or watched is a moving image, and an image-reproducing speed of said second picture taken or watched and/or said message information which are displayed as assembled is controlled depending on an amount of said message information.

19. The information transmitting system according to claim 12, wherein said specified object registers a category of said message information to be transmitted to said message information transmitting unit, and said message information transmitting unit transmits only the message information coincident with said registered category to said specified object.

20. The information transmitting system according to claim 12, wherein said specified object or said photographer transmits present situation information of one's own self to said message information transmitting unit, and said message information transmitting unit transmits the message information which is controlled depending on said present situation information to said specified object.

21. The information transmitting system according to claim 12, wherein said specified object or said photographer transmits present situation information of one's own self to destination designated by one's own self, said message information transmitting unit transmits said message information to said designated destination of one's own self, and said designated destination of one's own self processes said message information depending on said present situation information and transmits said processed message information to said specified object.
